(19) United States
(12) Patent Application Publication
(10) Pub. No.: US 2008/0150196 A1
(43) Pub. Date: Jun. 26, 2008

(54) Device for demolding concrete products

(76) Inventor: Luc Anna Philomena Van Cauwenbergh, Duffel (BE)

Correspondence Address: BACON & THOMAS, PLLC, 625 SLATERS LANE, FOURTH FLOOR, ALEXANDRIA, VA, 22314, US

(21) Appl. No.: 12/000,946

(22) Filed: Dec. 19, 2007

(30) Foreign Application Priority Data
Dec. 21, 2006 (BE) 2006/0640

(51) Int. Cl. B28B 13/06

(52) U.S. Cl. 264/334; 425/440

(57) ABSTRACT

Device for demolding concrete products (10) which mainly consists of a drum (8) that can be driven while rotating, and of means (17, 21) which make it possible to guide a mold (9) for concrete products (10) round the drum (8), characterized in that the device (1) comprises a shaft (11) extending at a certain distance from and parallel to the drum (8), and which is provided with at least one protrusion (12) at its girth which can remove the formed concrete products (10) while the mold (9) is being guided round the drum (8).

The present invention concerns a device for demolding concrete products.

As is known, concrete slabs are made by casting concrete mortar in flexible molds and by making it set, after which the slabs must be removed from the molds before they can be packed for transport.

Known devices for demolding slabs mainly consist of a conveyor belt via which the molds with the slabs are supplied, and of a drum that is suspended above the conveyor belt.

The drum is provided in a rotating manner on a shaft extending crosswise in relation to the conveyor belt. At a distance, along the outer surface of the drum, are provided several guide rollers extending parallel to the drum.

The drum is further provided with a carrier provided in a rotating manner on the shaft of the drum, and which makes it possible to guide a mold, supplied via the conveyor belt, around the drum, until a far end of the mold is situated between the outer surface and the guide rollers and can thus be guided further over the drum.

By guiding the mold around the drum, the dies in the mold are pulled open, as a result of which the slabs drop from the mold onto the conveyor belt, while the mold itself is being guided further round the drum.

Although the above-described device allows for a good demolding of slabs with a small thickness/surface ratio, it is not suitable for demolding slabs with a relatively large thickness/surface ratio, as is the case for example with clinkers or concrete cobbles.

The present invention aims a device which makes it possible to demold concrete slabs with a relatively large thickness/surface ratio.

To this end, the invention concerns a device for demolding concrete products, which mainly consists of a drum that can be driven while rotating and of means which make it possible to guide a mold for concrete products round the drum, whereby the device comprises a shaft extending at a certain distance from and parallel to the drum and which has at least one protrusion at its girth which can remove the formed concrete products from the mold while the mold is being guided round the drum.

An advantage of the invention is that it becomes possible to remove concrete products in an efficient manner from a mold, also when these concrete products have a relatively large thickness/surface ratio.

Indeed, by guiding the mold round the drum, the mold is bent, as a result of which the concrete products protrude a little from the mold, whereby the protrusion from the shaft can act exactly on this protruding part of the concrete products in order to remove the concrete products from the mold.

According to a preferred embodiment, the above-mentioned shaft can be driven while rotating in the same sense of rotation as the drum.

The advantage that is obtained with this preferred embodiment is double. First of all, at a constant speed of the drum, the concrete products are removed faster from the mold than when the shaft is standing still, since the force that acts on the protruding part of the concrete products is larger. Secondly, the risk of jams while the device is operational is reduced, since the concrete products are pushed away from the shaft and out of the mold.

According to another preferred embodiment, the above-mentioned shaft comprises several protrusions in the shape of diagonal fingers.

This preferred embodiment is advantageous in that the risk for concrete products to become jammed between the protrusion of the shaft and the mold that is being guided around the drum is reduced, since sufficient mutual space can be provided between the different fingers for the discharge of concrete products.

According to yet another preferred embodiment, the shaft can be driven while rotating in the same sense of rotation as the drum, and the shaft comprises several series of fingers that are each inserted in a different section of the shaft.

An advantage of this embodiment is that the rotational speed of the shaft can be selected relatively low, since the shaft must only rotate over a restricted angle before a series of fingers can make contact with the concrete products.

Thanks to this lower speed requirement, the shaft can be driven at a relatively large torque, such that the concrete products can be efficiently removed from the mold on the one hand, also in case of a large depth /surface ratio, and are less easily damaged by the impact of the fingers on the concrete products on the other hand.

According to yet another preferred embodiment of a device according to the invention, the device comprises a conveyor belt for supplying a mold with concrete products, whereby along this conveyor belt, upstream of the drum, is provided an assembly of at least three parallel shafts erected in a triangle and in between which the conveyor belt is guided, whereby the shafts of this assembly are mutually positioned in such a manner that the perpendical of the formed triangle, measured as of the shaft of the assembly that is situated on the opposite side of the conveyor belt in comparison to the other two shafts, has a size which is smaller than the thickness of the mold to be demolded.

An advantage of this preferred embodiment is that the device makes it possible to somewhat fold the mold before it reaches the drum, such that air can penetrate between the mold and the concrete products set therein. This penetration of air simplifies the removal of the concrete products from the mold while it is being guided round the drum.

The present invention also concerns a method for demolding concrete products, whereby a mold with concrete products is guided round a rotating drum in such a manner that the concrete products protrude at least a little from the mold, and whereby, at a certain distance from the drum, a shaft is provided extending parallel to the drum, and which makes contact with the protruding part of the concrete products as the mold is being guided round the drum, such that the latter are removed from the drum.

In order to better explain the characteristics of the invention, the following preferred device and method according to the invention for demolding concrete products are described hereafter as an example only without being limitative in any way, with reference to the accompanying drawings, in which:

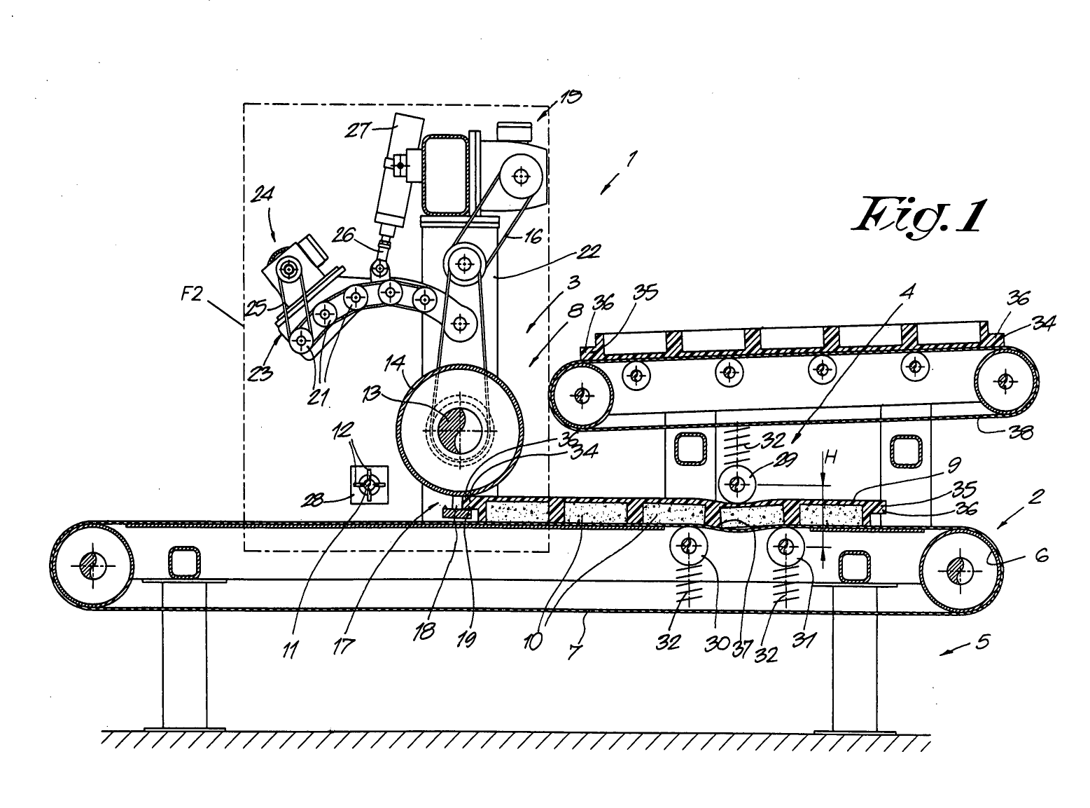

FIG. 1 schematically represents a device according to the invention seen as a section;

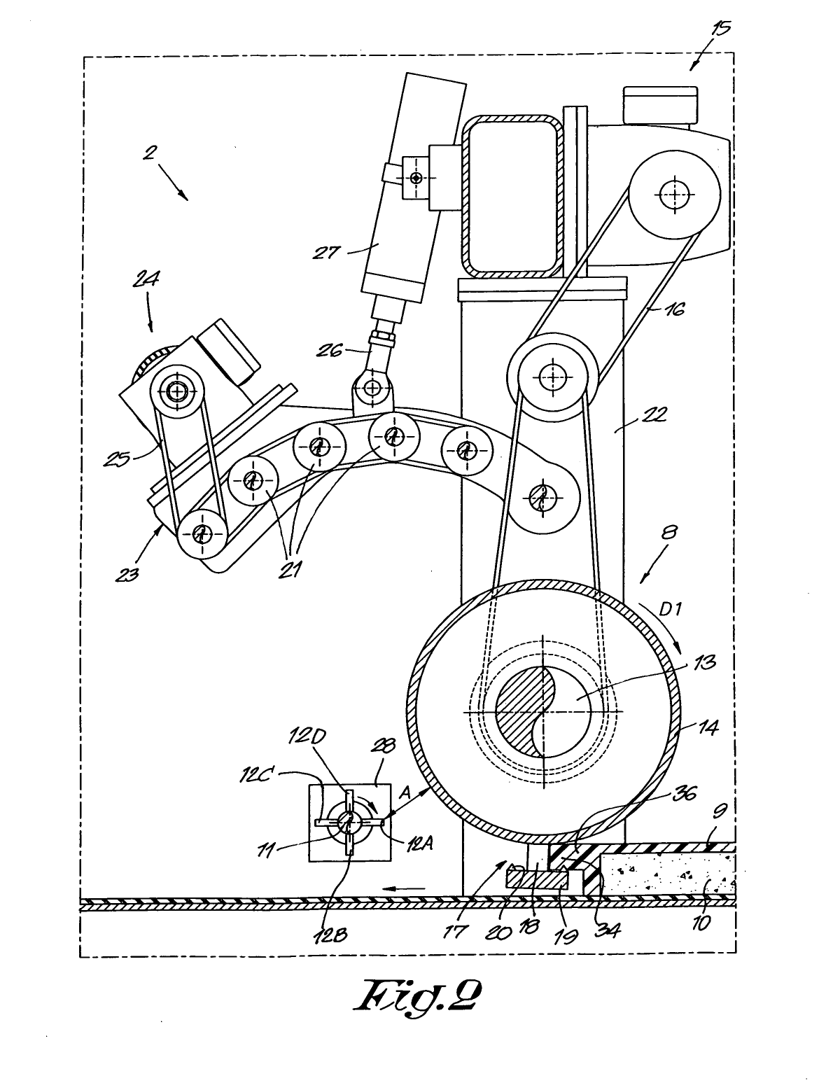

FIG. 2 represents the part indicated by F2 in FIG. 1 to a larger scale;

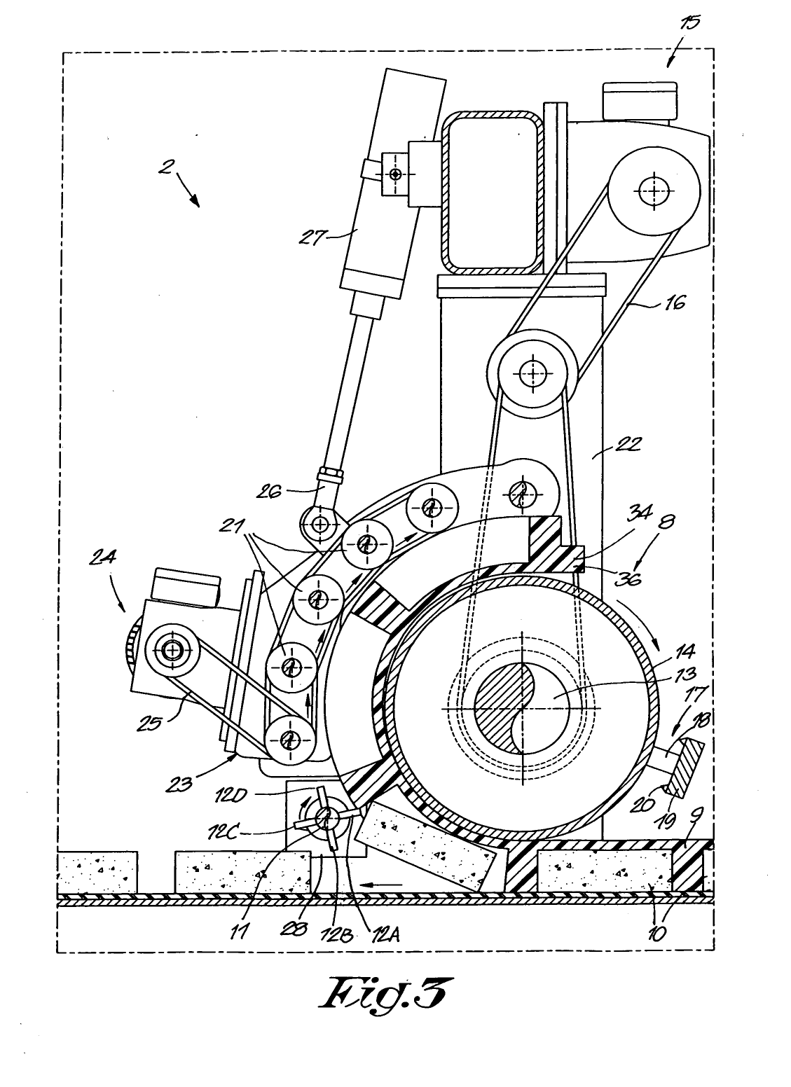

FIG. 3 represents the same view as in FIG. 2, but for another operational position of the device.

FIG. 1 represents a device 1 according to the invention which mainly consists of a conveyor belt 2 along which a first processing unit 3 and an optional second processing unit 4 are provided.

The conveyor belt 2 in this case consists of a frame 5 on which are provided guides 6 over which an endless chain 7 or belt is being driven while rotating by means of a drive that is not represented in the figures.

The first processing unit 3 mainly consists of a drum 8 that can be driven while rotating, and of means which make it possible to guide a flexible mold 9 for concrete products 10 round the drum 8.

According to the invention, this processing unit 3 also comprises a shaft 11, extending at a certain distance A from and parallel to the drum 8, and which has at least one protrusion 12 at its girth which can remove the formed concrete products 10 from the mold 9 as the mold 9 is being guided round the drum 8.

The drum. 8 is formed of a central shaft 13 around which is provided a cylindrical body 14, which can be driven while rotating by means of a drive 15 and a belt or chain transmission 16.

The above-mentioned means for guiding the mold 9 round the drum 8 in this case consist of a clamping unit 17 with two arms 18, only one of which is represented in the drawings, which are both bearing-mounted round the central shaft 13 of the drum 8, and in between which is provided a head piece 19 extending parallel to and over the entire length of the drum 8. This head piece 19, in the shape of a lath, is situated at a distance outside the cylindrical body of the drum 3.

As is represented in FIG. 2, the head piece 19 is preferably provided, on its surface directed towards the drum 8, with one or several unevennesses 20 which allow for a good grip of said surface on the mold 9.

The clamping unit 17 is in this case driven while rotating and it is provided with means which make it possible to vary the mutual distance between the head piece 19 and the drum 8 as a function of at least the position of the clamping unit 17 in relation to the drum 8.

The means for varying the mutual distance between the head piece 19 and the drum 8 are not represented in the figures, but they may consist for example of a guide fixed round the central shaft 13 of the drum 8, and of a pen provided on one of the arms 18 and which can move in the guide. It is clear that, in the latter case, the arms 18 should be variable in length, for example by making them telescopic.

The above-mentioned means for guiding the mold 9 round the drum 3 preferably also comprise a series of parallel rollers 21 that can move in relation to the drum 8 and that are fixed in a rotating manner on a supporting structure 22.

As is represented in greater detail in FIGS. 2 and 3, the rollers 21 are provided in a frame 23 which is bent in this case, such that the rollers 21 are positioned next to one another, in a bent configuration that covers a section of a cylinder.

The rollers 21 are preferably provided with a common drive 24, which is in this case mounted on the frame 23 and which works in conjunction with the rollers 21 by means of a belt transmission 25. The above-mentioned drive 24 makes it possible to drive the rollers 21 in a sense of rotation that is opposite to the sense of rotation D1 of the drum 8.

The frame 23 itself is fixed to the supporting structure 22 in a pivoting manner on the one hand, and to the piston rod 26 of a piston 27 on the other hand, which is provided on the above-mentioned supporting structure 22.

Finally, the first processing unit 3 comprises the above-mentioned shaft 11, which is in this case provided with four series of protrusions 12A-12B-12C-12D in the shape of fingers.

The different series 12A-12B-12C-12D are in this case provided on different sections of the shaft 11, such that in the given embodiment, a series of protrusions 12A-12B-12C-12D is provided at every 90° of the shaft.

The shaft 11 is in this case driven in the same sense of rotation D1 as the drum 8, by means of a motor 28 that is schematically represented in the figures.

The second, optional processing unit 4 is positioned upstream in relation to the drum 8 along the conveyor belt 2.

This second processing unit 4 is formed of an assembly of at least three parallel shafts 29-30-31, arranged in a triangular manner, and in between which the conveyor belt 2, or better still, the endless belt 7 or chain is guided.

In this case, a first shaft 29 is erected on the transport side of the belt 7 or chain, whereby the guide 2 of the belt 7 opposite said shaft 29 has been locally removed. Instead of the guide, both other shafts 30 and 31 of the assembly are provided.

It should be noted that the shafts of the triangle are positioned such that the perpendical H of the formed triangle, measured as of the shaft 29 of the triangle situated on the opposite side of the conveyor belt 2 in comparison to both other shafts 30-31, has a length that is smaller than the thickness of the mold 9 to be demolded.

The shafts 29 to 31 are preferably fixed in a springy manner to the frame 5 by means of springs 32 that can be compressed in a diagonal direction in relation to the conveyor belt 2.

It is clear that this assembly of shafts may also comprise more than three shafts 29 to 31, whereby they define more than two or more triangles then. Moreover, it is also possible to provide more than two shafts 29 on the transport side of the conveyor belt 2, whereas only one shaft 30-31 is provided on the opposite side of the conveyor belt.

If required, the shafts 29 to 31 can be driven while rotating.

The working of the present invention is simple and as follows.

While the device according to the invention is operational, the conveyor belt 2 for supplying molds 9 with set concrete products 10 is being driven.

These molds 9 consist, as is known, of a flexible plastic, in which openings are provided in one side, i.e. the open side, whose side walls define a shape that is complementary to the concrete products 10 to be formed.

The opposite side of the mold 9 is indicated as the back 33.

On at least two opposite side walls 34-35 of the mold 9 are provided diagonally protruding ribs 36.

The molds 9 are in this case directed with their open side towards the conveyor belt 2, provided on this belt 2, and at first instance they are guided through the assembly of shafts 29 to 31 of the second processing unit 4.

The specific arrangement of said shafts 29 to 31 and the restriction of the length of the perpendical H results in that the mold 9 is bent somewhat at the passage between the assembly of shafts 29 to 31.

Since the set concrete products 10 cannot bend along, small air slots 37 are created between the side walls of the mold 9 and the concrete products 10 in the mold 9, through which air can penetrate between the mold 9 and the concrete products 10.

It is clear that the presence of air between the mold 9 and the concrete products 10 makes it possible to remove the concrete products 10 more easily from the mold 9 in a later phase.

Secondly, and as represented in FIG. 2, the molds 9 are supplied to the first processing unit 3. The arrangement of this first processing unit 3 in relation to the conveyor belt 2 is such that the molds 9 are directed with their backs to the drum 8.

When supplying the mold 9 to the first processing unit 3, the frame 23 with the above-mentioned series of rollers 21 is put in an open position.

The supply of the molds 9 is synchronized with the movement of the above-mentioned clamping unit 17, whereby the mold 9 is clamped at one of its ribs 36 between the head piece 19 of the clamping unit 17 and the drum 8. The irregularities that are provided on the surface of the head piece 19 directed towards the drum 8 provide for a good grip of this head piece 19 on the rib 37 of the mold 9 concerned.

Subsequently, the clamping unit 17 is turned at the same speed and in the same sense of rotation D1 as the drum 8, as a result of which the mold 9 is guided round the drum 8.

When guiding the mold 9 round the drum 8, the mold 9 is pulled open somewhat, whereby the concrete products 10 protrude a little from the mold 9 with their edges.

When the mold 9 is guided further round the drum 8, it is precisely this protruding part of the concrete products 10 that will make contact with the protrusions 12 of the shaft 11, which is provided at an accurately determined distance A from the drum 8 to this end.

Thanks to this contact, the concrete product is pushed out of the mold so to say.

As soon as the clamping unit 17 and the drum 8 have rotated into a position in which the clamping unit 17 is positioned beyond the frame 23 and the rollers 21, the piston 27 will be reinforced and the frame 23 will be put in a closed position, whereby the mold 9 is guided between the drum 8 and the rollers 21.

As is represented in FIG. 3, the clamping unit 17 can be detached from the mold 9 as of this moment, and it is then moved further, at a rotational speed that is higher than the rotational speed of the drum 8, until the clamping unit clamps the rib 36 at the rear end of the mold 9 against the drum 8.

This clamping must make sure that the far end of the mold 9 stays stuck against the drum 8 since, if not, the mold will not be pulled open enough for the concrete products 10 that are in the vicinity of said far end in the mold 9 to be smoothly removed.

Next, the clamping unit 17 is rotated further together with the drum 8 or at a lower rotational speed, such that the mold 9 is guided further in a good, stretched position until all the concrete products have been removed from the mold 9.

Beyond the rollers 21, the mold is no longer guided, and the empty mold 9 will come off the drum as a result of its elasticity after which it can be discharged, for example via an additional conveyor belt 38.

Once all the concrete products have been removed from the mold, the frame 23 is put in an open position again, while the clamping unit 17 keeps on guiding the rear end of the mold until the mold can be entirely discharged via the additional conveyor belt 38.

From there on, the clamping unit 17 rotates further so as to guide a subsequent mold 9 on the conveyor belt 2, after which the above-described cycle is resumed.

It is clear that when the shaft 11 with the protrusions 12 is driven while rotating in the same sense of rotation as the drum 8, the concrete products 10 can be removed in a more efficient manner from the mold 9.

The present invention is by no means restricted to the method described above and represented in the accompanying drawings; on the contrary, such a method according to the invention can be made in all sorts of variants while still remaining within the scope of the invention.

1. Device for demolding concrete products, comprising a drum arranged to be driven in rotation; a guide arrangement enabling a mold for concrete products to be guided round the drum; a shaft extending at a certain distance from and parallel to the drum, said shaft including at least one protrusion at its girth; said protrusion arranged to remove formed concrete products from the mold while the mold is being guided round the drum.

2. Device according to claim 1, wherein the shaft is driven in rotation in the same sense of rotation as the drum.

3. Device according to claim 1, wherein the shaft has several protrusions in the shape of cross fingers.

4. Device according to claim 3, wherein on the shaft there is provided several series of said fingers, each series comprising a number of said cross fingers which are positioned next to one another along the longitudinal direction of the shaft, and wherein the different series are provided on different sections of the shaft.

5. Device according to claim 1, wherein the guide arrangement comprises a clamping unit rotatable in a relationship with the drum.

6. Device according to claim 5, wherein the clamping unit includes a head piece which is moveable at an adjustable distance from the drum.

7. Device according to claim 6, wherein the head piece includes a surface which is directed towards the drum, and wherein a gripping unevenness is provided on said surface.

8. Device according to claim 5, wherein the head piece is provided on a rod which is bearing-mounted round a central shaft of the drum.

9. Device according to claim 1, wherein the guiding arrangement comprises a series of rollers extending parallel to the drum, and which are positioned at a certain distance from the drum.

10. Device according to claim 9, wherein the series of rollers is moveable in relation to the drum, between a closed position at which the rollers are positioned at the certain distance from the drum, and an open position at which the rollers are further removed from the drum.

11. Device according to claim 1, including a conveyor belt for supplying a mold with concrete products, and wherein along the conveyor belt, upstream of the drum, is provided an assembly of at least three parallel shafts arranged as a triangle and in between which the conveyor belt is guided, and further wherein the shafts forming of the triangle are positioned such that the vertical height of the formed triangle, measured from the shaft of one triangle that is situated on one side of the conveyor belt to the other two shafts situated on the opposite side of the conveyor belt, has a length that is smaller than the thickness of a mold to be demolded.

12. Method for demolding concrete products, whereby a mold with concrete products is guided round a rotating drum, and the concrete products protrude at least a little from the mold, comprising the steps: at a certain distance from the drum there is provided a shaft extending parallel to the drum and which makes contact with the protruding part of the concrete products, while the mold is being guided round the drum, such that the latter are removed from the mold.

13. Method according to claim 12, wherein the shaft is driven in the same sense of rotation as the drum.

14. Method according to claim 13, wherein the mold is guided round the drum by means of a clamping unit which clamps the mold against the drum and which rotates at the same rotational speed and in the same sense of rotation as the drum.

15. Method according to claim 14, wherein the mold is guided round the drum by means of the clamping unit, until a far end of the mold is situated between the drum and a series of guide rollers, which rollers take over the further guiding of the mold, after which the clamping unit rotates further round the drum at a rotational speed that is higher than the rotational speed of the drum, and subsequently clamps the other far end of the mold against the drum, as of which moment the clamping unit is driven at a rotational speed that is a little lower than or equal to the rotational speed of the drum, so as to guide the far end of the mold along the drum.
